(19) United States
(12) Patent Application Publication
(10) Pub. No.: US 2025/0200495 A1
(43) Pub. Date: Jun. 19, 2025

(54) COMPUTER-IMPLEMENTED METHOD FOR DETERMINING A CONTROL STRATEGY FOR CONTROLLING A HANDLING PROCESS OF AT LEAST ONE HANDLING DEVICE FOR HANDLING PIECE GOODS, COMPUTER PROGRAM AND HANDLING DEVICE FOR HANDLING PIECE GOODS

(71) Applicant: Körber Supply Chain Logistics GmbH, Konstanz (DE)

(72) Inventors: Frank Pfeiffer, Reichenau (DE); Martin Schall, Konstanz (DE); Michael Zettler, Allensbach (DE)

(21) Appl. No.: 18/978,761

(22) Filed: Dec. 12, 2024

(30) Foreign Application Priority Data
Dec. 13, 2023 (DE) 10 2023 134 877.9

(51) Int. Cl. G06Q 10/083; G06Q 10/0639

(52) U.S. Cl. CPC G06Q 10/083; G06Q 10/06393

(57) ABSTRACT

A computer-implemented method for determining a control strategy for controlling a handling process of at least one handling device for handling piece goods includes detecting or obtaining at least one piece good information of at least one piece good which has been handled by the handling device, transmitting the at least one piece good information to a data center, determining at least one key performance indicator of the handling process of the handling device based on the at least one piece good information, determining a control strategy for the at least one handling device based on the at least one key performance indicator, a related computer program and a related handling device.

### BACKGROUND OF THE INVENTION

The present disclosure relates to a computer-implemented method for determining a control strategy for controlling a handling process of at least one handling device for handling piece goods, a computer program and a handling device for handling piece goods in a handling process.

It is often difficult to adapt the control strategies of handling devices in operation due to changing boundary conditions. For example, handling devices that handle piece goods are often problematic when the piece goods change. In other words, it can happen that unit loads change in unpredictable ways. In recent years, for example, there has been a shift from rather rigid piece goods to flexible and often only partially filled pocket-like piece goods. Handling devices are often adapted iteratively on the basis of a user's observations. For example, the control of handling devices is fine-tuned manually in order to avoid the occurrence of handling errors.

However, such an approach is often subjective and depends on the user's personal experience. Furthermore, manual control is time-consuming and it is often not possible to take all boundary conditions into account at the same time.

Therefore, it is an object of the present disclosure to provide a method and a device which can adapt a control of a handling device for piece goods to changing boundary conditions.

### SUMMARY OF THE INVENTION

According to an aspect of the present disclosure, there is provided a computer-implemented method for determining a control strategy for controlling a handling process of at least one handling device for handling piece goods. The method may comprise: An acquiring or obtaining at least one piece good information of at least one piece good handled by the handling device. The method may further comprise: Transmitting the at least one item of item information to a data center. Furthermore, the method may comprise: A determining at least one key performance indicator of the handling process of the handling device based on the at least one piece good information. The method may comprise: Determining a control strategy for the at least one handling device based on the at least one key performance indicator.

Compared to the known state of the art, the object of the present disclosure provides the advantage that the data center can adapt a control strategy of the handling device based on key performance indicators of the handling device. This makes it possible to react automatically to changing boundary conditions, such as a changing range of items. Furthermore, by taking at least one key performance indicator into account, an objective evaluation criterion can be used to adapt the control strategy.

The handling system can be a process in which piece goods are physically handled. More specifically, the process may be a process of separation, a sorting process and/or any other process in which a piece good is physically moved. Thus, the handling may involve physically moving the piece good. The control strategy may be a handling strategy of the piece good. The control strategy may, for example, be applied by a control device. The control strategy may be responsible for control instructions according to which the handling device is controlled. For example, input data can be fed to the control device, whereupon the control device processes the input data based on the control strategy and outputs output data. The output data can include control instructions for controlling the handling device. This means that the control instructions can be directly dependent on the control strategy. In other words, if the control strategy is changed, the control commands can also be changed. A piece good can be any object to be handled. For example, a piece good may be a parcel, a package, a mailing bag, a shipping bag, smalls, polybags or the like. For example, the piece good may be a piece of mail. Furthermore, the piece goods can also be goods that are imported into and exported from a warehouse, for example. In addition, the piece goods can also be containers in which goods are transported, such as in a warehouse. It is also conceivable that piece goods can also include luggage, suitcases and bags. Piece good information can be indicative of a property of the piece good. Furthermore, the piece good information can be indicative of information relating to the piece good that has accumulated during a handling process. For example, the piece good information may include a failed handling of the piece good. The item information can itself comprise a variety of information. However, a variety of item information can also be used. For example, piece goods information can be generated at each detection location. The piece good information can also only be indicative of the presence of a piece good. The item information can be recorded directly in the handling device itself. Furthermore, the item information may also have been recorded by another handling device or detection device. For example, the at least one piece of piece goods information may be detected by a device arranged upstream and/or downstream of the handling device in the stream of piece goods. In such a case, the method can be provided with the at least one piece of piece goods information. This means that the handling device does not have to detect the piece goods information itself. The at least one item of item information can be obtained via a data line. Furthermore, the piece good information can be indicative of how the piece good was handled in the handling device. The at least one piece of piece good information can be recorded or obtained after the piece good has been handled in the handling device. This can ensure that a success or failure of the handling of the piece good in the handling device is included in the at least one piece of information. The item information can then be transmitted to a data center. The data center can be arranged at a different location than the handling device. For example, the data center can be connected to the handling device via the Internet. The data center can also be accessible via a cloud or be provided in a cloud. The data center can have a bidirectional data line with the handling device. This can ensure that the handling device can send data to the data center and the data center can send data to the handling device. The data center can, for example, have greater computing power than the handling device (e.g., a control unit housed in the handling device). This can ensure that the control strategy can be determined efficiently and/or quickly. Furthermore, it can be avoided that the handling process suffers as a result of determining the control strategy in the handling device itself because computing capacities have to be used to determine or apply the control strategy. Furthermore, a centralized data center offers the advantage that unit load information from a large number of handling devices can be used to determine control strategies. The data center can then determine at least one key performance indicator of the handling process of the handling device. The key performance indicator may be a key performance indicator (KPI or key performance indicator). The key performance indicator can characterize a handling process of a piece good in the handling device. The key performance indicator can be used to measure or determine progress or a degree of fulfillment with regard to set objectives or critical success factors. The key performance indicator can be, for example, a desired success of the handling process. These can be defined in advance. This allows the operator of the handling device to define the purpose or performance of the handling device in the specific application situation. By determining the control strategy based on the key performance indicator, it can be ensured that the handling device also achieves the desired performance (for example, by adapting the control strategy based on the key performance indicator). The key performance indicator can be determined based on the at least one piece of cargo information. For example, the piece good information may indicate how many piece goods are handled. The key performance indicator may indicate an efficiency of piece goods per unit of time based on this information. The unit load information can also indicate mishandling. Based on this, the key performance indicator can indicate what percentage of handling processes are successful. Finally, the data center may determine a control strategy for the at least one handling device based on the at least one key performance indicator. The data center may further determine the control strategy based on the at least one piece of item information and the at least one key performance indicator. The control strategy may, for example, be adapted by the data center to check whether a different key performance indicator is obtained. For example, the data center can monitor the key performance indicator. This allows changes to be detected. Such a change can occur, for example, if piece goods change (e.g., their properties and/or designs). The data center can then adapt the control strategy and compare the new key performance indicator with the old key performance indicator. A difference between the new key performance indicator and the old key performance indicator can then be used to check whether the change has a positive effect or not. This can provide an optimization of the key performance indicator, which can run automatically and centrally. In other words, the data center can iteratively check which change has a positive effect on the key performance indicator. This allows it to react automatically to changing boundary conditions. For example, the data center can be designed to simulate the handling process in the data center. Here, the unit load information supplied by the handling device can be used as the basis for the simulation in order to simulate the actual unit load flow at the handling device, i.e., the boundary conditions prevailing there. By adapting the control strategy, it is then possible to check whether one or more key performance indicators change. It can also be checked whether at least one key performance indicator changes positively or negatively. In other words, it can be checked whether the desired key performance indicator is achieved or not. By determining the at least one key performance indicator in the data center, an optimization of the control method can be carried out away from the handling device itself. This can prevent the handling process from being influenced by optimizing the control strategy. Furthermore, by simulating the handling process in the data center, changes can be implemented extremely quickly and easily without the need to restart or reprogram the handling device itself. This makes it easy to change the control strategy and iteratively check whether a changed control strategy leads to the desired key performance indicator. This makes it easy to adapt to changing boundary conditions. Such an optimization of the control strategy can even be used for handling devices that are already established or in use. This ensures that the handling process maintains a high level of quality and performance without errors occurring during handling.

Optionally, the method further comprises: transmitting the control strategy to the at least one handling device. In other words, the new control strategy determined by the data center can be transmitted to the handling device. The new control strategy can then be implemented and applied at the location of the handling device. The transfer can take place at a predetermined time. For example, a release command can be received by the data center, whereupon the new control strategy can be transmitted. This can ensure that the new control strategy is not transmitted while the handling device is in operation, which can lead to problems during operation. Furthermore, the new control strategy can only be transmitted if the operator of the handling device so wishes. In this way, the operation of the handling device can be ensured. Furthermore, the new control strategy can also be transmitted to other handling devices. This means that a newly determined control strategy can be applied to several handling devices. This means that general trends, such as changes in the properties of the piece goods, can be countered without the need for individual consideration of the local boundary conditions each time.

Optionally, the at least one piece good information comprises position and location information of the piece good in the handling device. The piece good information can be detected several times during a passage or handling of the piece good in the handling device. For example, a piece good can be analyzed at the beginning of the handling process by the handling device to obtain the at least one piece good information. The piece good can then be analyzed again, for example depending on its position and/or an elapsed time, in order to obtain further piece good information. In this way, a position and/or a location of the piece good can be continuously detected while it is being handled by the handling device. The position information can be indicative of a spatial position of the piece good. The position information can be indicative of a relative position of the piece good to the handling device or elements of the handling device. For example, it is important that a control device or control unit of the handling device has knowledge of which subcomponents of the handling device must be controlled in order to handle a particular piece good in a desired manner. Furthermore, the at least one piece good information can also be obtained after the piece good has been handled. This makes it possible to evaluate whether handling of the piece good was successful or not. For example, the handling device is a singulator, so that piece good information at the end of the singulator can be used to determine whether the piece good has been successfully singulated (i.e., separated) or not. Furthermore, the singulator can have a large number of individual controllable sub-components, so that it is important for the control strategy to know which sub-components the respective piece good is resting on. This means that the position and orientation information of the piece good can be used to determine successful handling of the piece good.

Optionally, the at least one piece good information item has position information of the piece good relative to the handling device. This means that it is not necessary to map the position information of the piece good to world coordinates, for example. This can simplify the handling of the item information.

Optionally, a variety of piece good information of the piece good is recorded or obtained during the handling process of the handling device. This allows changes that occur during the handling of the piece good in the handling device to be recorded. For example, the handling of the piece good can thus be monitored.

Optionally, the at least one item of item information is at least partially recorded by an optical system, in particular the handling device. The optical system may, for example, comprise one or more cameras. The at least one piece of piece good information can thus comprise one or more images of the piece good. Based on the at least one image of the piece good, further piece good information can be derived. For example, the location and position of the piece good in the handling device can be derived from an image. In order to reduce the amount of data, the image of the piece good can be simplified. For example, a polygon representation of the piece good can be created based on the image of the piece good. Optionally, the corners of the piece good are recognized and defined as such. The corners are then connected by straight lines. This allows a polygon representation to be created. Such a polygon representation requires significantly less storage space and is therefore faster and easier to process and/or send. Optionally, four corners can be defined for each piece good. This means that even a piece good with more or fewer corners can be approximated almost exactly, so that control with these simplifications is possible without any problems. By defining the number of corners, the detection process can be accelerated and misinterpretation can be avoided. Overall, this can make the detection system more robust. The optical system can be provided in the handling device itself. Alternatively or additionally, the optical system can also be connected upstream or downstream of the handling system. Optionally, the optical system is provided vertically above the piece goods to be handled in the handling system. This allows two-dimensional handling of the piece goods to be realized in a simple manner.

Optionally, the at least one piece of piece good information comprises a time stamp, a weight of the piece of good, a condition of the piece of good, packaging information, address information, sender information and/or information about a center of gravity of the piece of good. This means that the control strategy can be based on further properties of the piece goods. The time stamp can be indicative of when the item information was obtained. Thus, the piece good information can be assigned to a point in time during the handling of the piece good by the handling device. This means that a relative change in the item information relative to item information recorded before or after can be determined. The time stamp does not have to include the current time, but can merely be a relative time at another point in time at which further piece goods information is recorded. The weight of the piece good can, for example, be determined in the handling device itself or by a previously completed process. The weight can play a role in the handling of the piece good if the piece good is particularly light or particularly heavy, as different handling parameters can be applied depending on the weight. The nature of the piece good can be indicative of whether, for example, a strap or other closing element is arranged on the outside of the piece good. For example, this can also influence the handling of the piece good. Furthermore, the piece good may have a protruding element that cannot be gripped mechanically during handling, for example. The packaging information can be indicative of the nature of the outer surface of the piece good. For example, poly bags may require different handling than cardboard. The address information can also be indicative of the properties of the piece good. For example, it can be determined that a private addressee often receives a certain type of piece good. Similarly, the sender information is indicative of what is sent in the piece goods. For example, if the sender is a bookstore, it can be assumed that the piece goods always contain a book or similar. The information about the center of gravity of the piece good can be important for handling the piece good. For example, a piece good that is relatively large but has its center of gravity in a corner may need to be handled differently than a piece good that has its center of gravity in the middle. Overall, the other piece good information mentioned allows the handling of the piece good to be applied more precisely to the respective piece good. More precisely, the control strategy can take all these boundary conditions into account and ensure that control instructions are issued individually to suit the respective piece good.

Optionally, capturing or obtaining the at least one piece good information comprises determining a contour of the piece good and determining a polygon representation of the piece good based on the contour. Thus, when using an optical system to capture the at least one piece of information, the size of the output data of the optical system can be reduced. More specifically, only an outline of the piece good can be used to obtain the polygon representation. This allows the data size to be reduced so that the piece goods information can be determined quickly and the piece goods information can be processed efficiently.

Optionally, the polygon representation is determined every 30 ms. The determination of the polygon representation may continue as long as the piece good is handled by the handling device. More specifically, the polygon representation can be determined at the beginning of the handling of the piece good by the handling device and then determined every 30 ms until the handling of the piece good by the handling device is completed. This can ensure that it is continuously monitored how the piece good is handled by the handling device.

Optionally, the at least one key performance indicator is indicative of a gap between two piece goods, an efficiency of piece goods per unit of time, a position of a piece good at the output of the handling device and/or an error rate of the handling of the piece good. This allows defined setpoints to be determined, which define the result of the handling of the handling device. The gap between 2 piece goods can be the smallest distance between 2 consecutive piece goods in the flow of piece goods. For example, in the case where the handling device is a singulator, it is necessary for the piece goods to be a desired distance apart. This can ensure further downstream handling of the piece goods. The efficiency of piece goods is the time it takes for a piece good to be handled by the handling device. For example, the efficiency in handled piece goods can be determined per unit of time, for example per hour. A position of a piece good at the output of the handling device can be indicative of whether the desired position of a piece good has been reached or not. For example, it may be desired that a piece good is oriented along its longest axis of extension. In this case, the position of the piece good at the end of the handling device can be used to determine whether the handling of the handling device was successful and the piece good is oriented as desired. A handling error rate can be indicative of how often a piece good has led to an error during handling in the handling device. For example, in the case where the handling device is a suction gripper, an error may occur when a piece good falls off the suction gripper. In the case where the handling device is a singulator, an error can occur, for example, if a piece good becomes jammed. The error rate can be used to define, for example, that when handling a piece good, an error may only occur in one percent of the handled piece goods. By defining at least one of the above key performance indicators, it is possible to individually adapt the control strategy of the handling device to the desired output.

Optionally, the at least one key performance indicator is output, in particular to a display device of the handling device. The key performance indicator can, for example, be determined in the handling device itself and/or in the data center. In any case, the at least one key performance indicator can be displayed to a user. Thus, the user can be shown transparently how the handling device functions and whether set key performance indicators are achieved or not. The display device can, for example, be a monitor on the handling device.

Optionally, a control strategy is determined by means of a digital twin of the handling device. Optionally, a control strategy is determined using a digital twin of the handling device in the data center. The data center can use a digital twin of the handling device to simulate the control strategy. A digital twin can be an exact, digital image of the handling device. For example, the digital twin can take into account the same physical and design principles as those that apply to the handling device in reality. Optionally, the finite element method can be used for this purpose. The digital twin can be created and calibrated during operation of the handling device based on the boundary conditions measured in reality. For example, the unit load information of a handling device operated in reality can be used to create a digital twin that reacts in exactly the same way as the handling device in reality. In particular, this can mean that a piece good that is handled in a certain way by the real handling device is also handled in the same way by the digital twin. The digital twin therefore makes it possible to make changes to the handling device or its control (i.e., the control strategy) without the need for complex adaptation or modification of the handling devices that exist in reality. The digital twin can be used to make iterative changes in a simple manner and to check the effect of these changes. In particular, at least one key performance indicator can also be obtained from a simulated operation of the digital twin. The key performance indicator of the digital twin obtained in this way can then be observed using a wide variety of control strategies. Due to the quick and easy implementation of a new control strategy in the digital twin, it can be determined even more quickly which change to the control strategy leads to which effects (or improvements).

Optionally, the digital twin simulates the handling process of the handling device. In other words, the handling process can be digitally simulated taking into account the boundary conditions that prevail in reality. The physical laws (e.g., gravity, friction, temperature and the like) can be taken into account as boundary conditions from reality. The information about the handling device itself can come from the user and/or the manufacturer. The information about the piece goods can be taken from at least one piece of information.

Optionally, a new control strategy can be tested using the digital twin. In other words, the control strategy of the digital twin can be adapted. For example, the speed at which the handling device handles the piece goods can be adapted. After adapting the control strategy, i.e., after implementing a new control strategy, the at least one key performance indicator provided by the digital twin can then be determined. This makes it possible to check which adjustment to the control strategy influences which key performance indicator and how. This is a simple way of checking how the handling device behaves with a modified control system. In particular, this procedure can be used to adapt a control system of the handling device so that it achieves the desired key performance indicator. For example, the control strategy of the digital twin can be adapted until an error rate reaches the desired range. Furthermore, the control strategy can also be adapted so that several key performance indicators are achieved. For example, the efficiency of the handling device can be increased, but at the same time there is a risk that this will also increase the error rate. The ability to check this with the digital twin with relatively little effort makes it possible to implement an optimally suitable control strategy.

Optionally, determining a new control strategy includes optimizing the new control strategy of the digital twin. In other words, optimizing may mean that the key performance indicator to be achieved by the handling device is achieved in the best possible way by the digital twin. In other words, it may be sufficient if the key performance indicator is essentially achieved or if a result approaches this key performance indicator without achieving it. This may be because it is often not possible to achieve a desired key performance indicator. For example, it may be impossible to achieve an error rate of 0%. Therefore, the process may involve optimizing the control strategy of the digital twin to achieve a result that is as close as possible to the desired key performance indicator.

Optionally, the method further comprises: comparing the control strategy of the handling devices with the new control strategy of the digital twin, and creating an evaluation of the control strategies based on the comparison. If a new control strategy has been created with the aid of the digital twin, it can be compared with the control strategy implemented in the real handling device. This makes it possible to check whether the new control strategy leads to better results than the control strategy already implemented. The result of this comparison can be the evaluation of the control strategies. Thus, the handling device, which exists in reality, can either be provided with a new control strategy or it can be determined that the handling device is already working at maximum optimization for the desired key performance indicators. Furthermore, the evaluation can be important information for a user of the handling device in order to adapt the operation of the handling device if necessary. In this way, a new control strategy can be applied, which does not necessarily provide improved handling of the piece goods overall, but can be advantageous for the respective individual operation of the handling device. For example, it may be advantageous for some areas to increase the efficiency of piece goods, even if an error rate increases at the same time. This method therefore offers the user the opportunity to optimize their handling device to suit their individual requirements.

Optionally, each piece good is considered individually when the piece good information is recorded or obtained. This can ensure that during the handling of a piece good, the piece good information, which is continuously obtained during handling, can be assigned individually to one piece good.

Optionally, the handling process of the handling device comprises the application of an algorithm, whereby the algorithm is designed based on the control strategy to output control instructions as output data based on piece goods information as input data. The algorithm can be implemented in a control unit of the handling device. The algorithm can be a learning algorithm. The algorithm can be stored in the control unit of the handling device. The algorithm can be based on or determined by the control strategy. The input data can, for example, be an image of the piece good to be handled, whereupon the control unit can determine (using the algorithm or the control strategy) how the specific piece good is to be handled. In order to achieve the desired handling of the piece good, the control unit can issue control instructions to the handling device. The control instructions can, for example, be indicative of which sub-component of the handling device is to be actuated and how in order to handle the piece good. Furthermore, the control instructions can be indicative of the speed at which sub-components of the handling device are to be operated. Furthermore, the control instructions can be indicative of the negative pressure with which the handling device is to be operated. The control strategy can thus only be a part of the algorithm that is intended to control the handling device. In other words, the control strategy can only be partially responsible for how a piece good is to be handled.

Optionally, the algorithm comprises a neural network. A neural network can comprise any number of interconnected neurons that form a correlation based on a specific function. The neural network can be designed to output data based on certain input data. In the present case, the neural network can be trained to output control commands for handling this piece good in the handling process as output data based on at least one piece of information. The neural network therefore maps input data to output data. In order to map the input data to the output data accordingly, weights or variables are defined that enable the input data to be mapped to the output data. The variables or weights can be part of equations. The variables or weights can be defined for the first time using a training process. The variables or weights can be adapted during operation of the neural network using a learning function. (i.e., they can be retrained). In the present case, this can be done, for example, by characterizing handling operations of piece goods as faulty or particularly advantageous, which allows the variables to be adjusted accordingly. Optionally, the control strategy is indicative of the variables or weights of the neural network. In other words, the basic structure of the neural network always remains constant and only the weights are changed by adjusting the control strategy. This ensures that the basic structure of the control of the handling device always remains the same and only minor adjustments are made to the control of the handling device.

Optionally, the algorithm includes a directed graph with weights. The equations can also be displayed graphically. The weights can be used to adjust or change individual areas of the graph. Displaying the algorithm as a graph can make it easier to use.

Optionally, the algorithm is a learning algorithm. In other words, it is possible for the algorithm to adapt itself based on the unit load information. This means that changes to boundary conditions can be taken into account automatically, for example. Optionally, however, the self-learning effect is limited so that a significant change to the control strategy is avoided. This means that unintentional retraining of the algorithm used in the handling device can be avoided.

Optionally, the algorithm has 800 to 1200, optionally essentially 1000, weights. It has been found that with this number of weights, a particularly advantageous control of handling devices in the unit load area can be achieved. Providing more weights, on the other hand, results in longer calculation times and higher power requirements for the control unit. If fewer weights are provided, problems can arise with a large number of different piece goods.

Optionally, the algorithm is designed to adapt the control strategy. In other words, the algorithm of the control unit of the handling device can allow weights, in particular, to be changed. This opens up the possibility of adapting the control strategy on site.

Optionally, unit load information from a large number of handling devices can be recorded in the data center. In other words, a variety of unit load information can be processed in the data center. This provides the advantage that a large amount of data can be used to develop a new control strategy. This means that new control strategies can be more robust and suitable for a wide range of piece goods.

According to one embodiment of the present, the unit load information is referred to as collected data. The collected data is the result of the so-called vision system running in each handling device (e.g. a singulator). It looks at the handling device from above and recognizes each element of the handling device based on its contour. As a result, a set of variable length polygons is delivered to the motion controller to issue control instructions to the handling device (e.g.: adjust a speed). The collected data is also transmitted to a data center (e.g. a Parcel Data Hub, PDH). This set of polygons is calculated every 30 ms. An application runs on the PDH to calculate the handling KPIs in real time (gap, efficiency, angle of a piece good at the exit and the error rate at the exit). This information is primarily used for transparency to compare either separation or flows over time. In a so-called fleet environment, a number of handling devices process piece goods in parallel and each handling device provides the data to a central PDH via a local PDH. This enables simple benchmarking or ranking of a group of handling devices. In addition, a digital twin (i.e., a digital twin) runs in the PDH. The digital twin models the handling devices, e.g. the relevant elements of the handling device, and is equipped with a deep reinforcement learning based agent. The agent can stimulate the speed of the elements of the handling device. During the self-adaptation phase, it receives feedback as to whether an action was positive or negative. Positive and negative in relation to the KPIs that are achieved as a result of an action. What the agent learns is stored in a neural network. The agent is trained with sequences of unit load information and/or key performance indicators generated by a real handling device—step one: once an agent has been trained in the simulation, its performance against the key performance indicators can be compared with reality, which is running at the time the unit load information and/or key performance indicators are recorded. If a self-customized control strategy performs better than the one currently implemented, the agent (neural network model) can be downloaded to the physical machine and activated. As a result, the control strategy has now learned how to deal with the current flow. It may also be relevant to learn faster based on a fleet approach. In this case, the agent is trained using data from several handling devices. Transfer learning can be used to prevent other handling devices from failing or losing power even without a problem being detected beforehand. The key performance indicators can also be combined with SmartMaintenance functions to correlate data and predict damage, motor or other failures more accurately or earlier.

According to a further aspect of the present disclosure, there is provided a use of the method according to any of the above embodiments for creating a control strategy.

According to another aspect of the present disclosure, there is provided a method for adapting a control strategy used for handling piece goods in a handling device for handling piece goods, wherein the control strategy is determined according to one of the above embodiments.

According to a further aspect of the present disclosure, there is provided a computer program comprising instructions which, when the program is executed by a computing unit, causes the computing unit to execute the method according to one of the above embodiments. This applies both to methods for determining a control strategy for controlling a handling process of at least one handling device for handling piece goods and for adapting a control strategy. Alternatively, the learning algorithms can also be implemented as hardware, e.g., with fixed connections on a chip or another computer unit. The computer unit that can execute the method according to the invention can be any computer unit such as a CPU (Central Processing Unit) or GPU (Graphics Processing Unit). The computing unit can be part of a computer, a cloud, a server, a mobile device such as a laptop, tablet computer, cell phone, smartphone, etc. In particular, the computer unit can be part of a monitoring system for determining the status of a handling device. The monitoring system may include a display device, such as a computer screen.

The disclosure also relates to a computer-readable medium comprising instructions which, when executed by a computing unit, cause the computing unit to perform the method according to the invention, in particular the above method. Such a computer-readable medium can be any digital storage medium, for example a hard disk, a server, a cloud or a computer, an optical or a magnetic digital storage medium, a CD-ROM, an SSD card, an SD card, a DVD or a USB or other memory stick. The computer program can also be obtained via the Internet.

According to a further aspect of the present disclosure, there is provided a handling device for handling piece goods in a handling process, comprising at least one controllable element for physically handling piece goods, a sensing device for sensing at least one piece good information of at least one piece good being handled during the handling process, a control device for controlling the at least one controllable element according to a control strategy based on the at least one piece good information, a transmitting device adapted to transmit the piece good information to a data center, a receiving device adapted to control the at least one controllable element according to a control strategy based on the at least one piece good information, and a control device for controlling the at least one controllable element according to a control strategy based on the at least one item of item information, a transmitting device designed to send the item information to a data center, a receiving device designed to receive a new transmission strategy from the data center, the control unit being designed to adapt the control strategy in accordance with the new control strategy. Adapting the control strategy can mean, for example, replacing the control strategy. The control device may be configured to perform a method according to one of the above claims.

### BRIEF DESCRIPTION OF THE DRAWINGS

Individual features or embodiments can be combined with other features or other embodiments to form new embodiments. Advantages and embodiments of the features and embodiments then apply analogously to the new embodiments. Advantages and embodiments mentioned in connection with the method also apply analogously to the device and vice versa.

In the following, embodiments are described in detail with reference to the attached figures:

FIG. 1 is a schematic flowchart of a method according to one embodiment of the present disclosure;

FIG. 2 is a schematic and perspective view of a handling device according to an embodiment of the present disclosure;

FIG. 3 is a schematic and perspective view of a part of a handling device according to an embodiment of the present disclosure;

FIG. 4 is a schematic view of a handling device according to an embodiment of the present disclosure;

FIG. 5 is a schematic view of a part of a handling device according to an embodiment of the present disclosure, during an operation of the handling device; and

FIG. 6 is a further handling device according to an embodiment of the present disclosure.

### DETAILED DESCRIPTION OF THE PREFERRED EMBODIMENTS

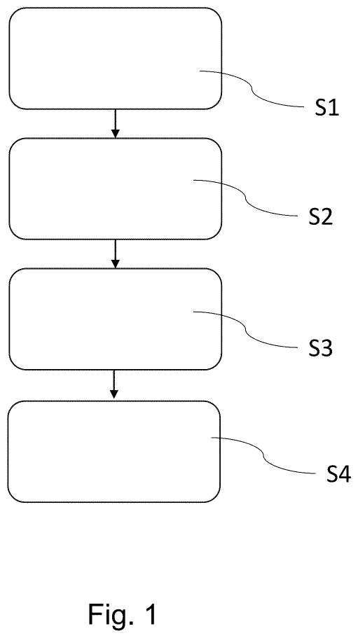

FIG. 1 is a schematic view of a flow chart of a method according to an embodiment of the present disclosure. The method is designed to determine a control strategy for controlling a handling process of at least one handling device for handling piece goods. The method is a computer-implemented method and controls other instances and devices through its application. In step S1, the method comprises detecting or obtaining at least one piece good information of at least one piece good that has been handled by the handling device. In other words, in step S1, information is obtained about a piece good that has been handled by the handling device. The information may include properties of the piece good and/or information about the handling process that has taken place. In step S2, the at least one item of item information is transmitted to a data center. In the present embodiment, the transmission takes place via the Internet, since the data center is located remotely from the handling device. In step S3, at least one key performance indicator of the handling process of the handling device is determined. Here, the key performance indicator is determined based on the at least one piece of item information that was previously transmitted. Subsequently, in step S4, a control strategy for the at least one handling direction is determined based on the at least one key performance indicator. The determination of the at least one key performance indicator can be carried out, for example, by specifying a desired key performance indicator.

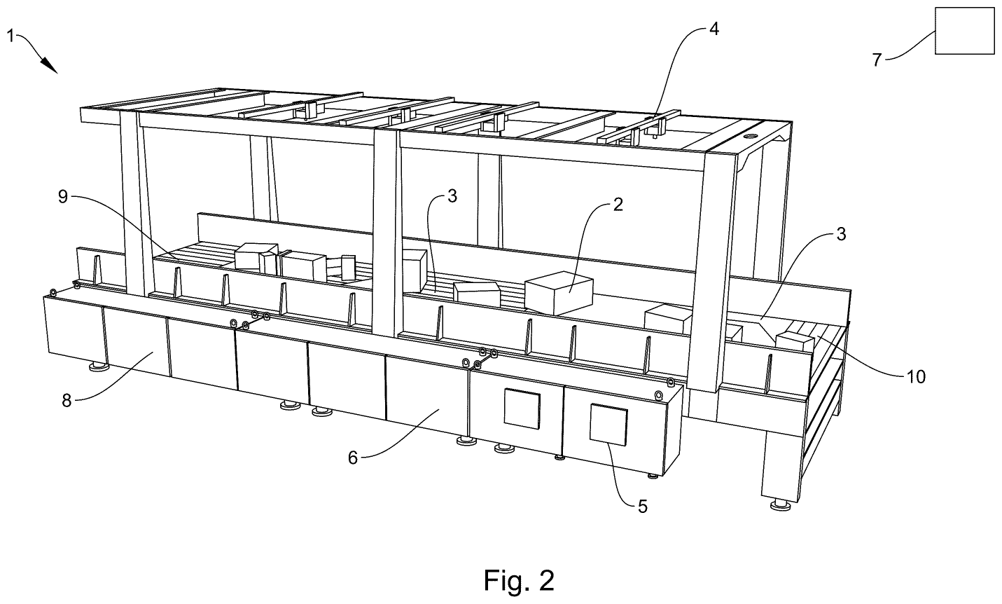

FIG. 2 is a schematic and perspective view of a handling device 1 for handling piece goods 2 in a handling process. In the present embodiment, the handling device 1 is a singular handling device. In other words, the handling device 1 of the present embodiment can turn a two-dimensional flow of piece goods into a one-dimensional flow of piece goods. For this purpose, the piece goods 2 are fed to the handling device 1 at an upstream end 9 of the handling device 1 and discharged from a downstream end 10 of the handling device 1. The handling device 1 has a plurality of controllable elements 3. In the present embodiment, the controllable elements are individually attached to controllable conveyor belts arranged in a matrix form on a conveyor surface of the handling device 1. In the present embodiment, the controllable elements 3 are arranged such that they are arranged in 7 columns and 8 rows in a plan view of the handling device 1. In a further embodiment not shown, the controllable elements 3 are arranged in 4 columns and 8 rows. The design of the handling device 1 can be selected based on the respective requirements for the use of the handling device 1. Furthermore, the handling device 1 has a detection device 4. The detection device 4 of the present embodiment has a plurality of cameras that are arranged vertically above the transport surface of the handling device 1 and record the piece goods 2 in a top view. The detection device 4 of the present embodiment determines the at least one piece good information of each piece good 2 which is handled by the handling device 1. Furthermore, the handling device 1 has a control device 5 for controlling the at least one controllable element 3. The control device its computer-like device, which has a CPU or GPU and can take in data, process data and output data. More specifically, the control device 5 takes in unit load information, processes it into control commands based on the control strategy, and outputs the control commands as output data to the controllable elements 3. Furthermore, the handling device 1 of the present embodiment has a transmission device 6, which is designed to transmit unit load information to a data center 7. The data center 7 is at a distance from the handling device 1 and is connected to the control device 5 of the handling device 1 via the Internet. Furthermore, the handling device 1 has a receiving device 8, which is designed to receive a new control strategy from the data center 7. The data center 7 can develop a new control strategy according to the method according to the invention and send it to the handling device. The control device 5 is designed to adapt or replace the control strategy in accordance with the new control strategy.

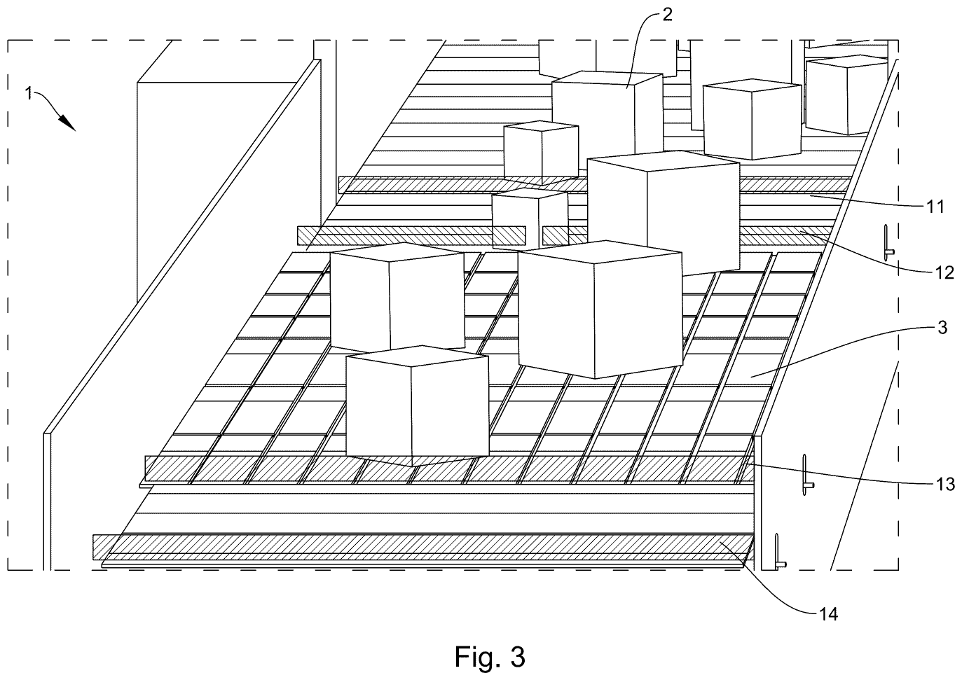

FIG. 3 is a schematic and perspective view of a part of the handling device 1 according to an embodiment of the present disclosure. In FIG. 3, the individual controllable elements 3, which are designed as individual conveyor belts, can be seen. In the background it can be seen that the piece goods 2 are fed, whereas in the foreground the piece goods leave the handling device. As they pass through the handling device 1, the piece goods are transferred from a 2D stream to a 1D stream (i.e., singulated or separated). In the present embodiment, the schematically indicated lines 11, 12, 13, 14 represent the points at which the piece goods that are handled by the handling device 1 are analyzed by the detection device 4. More precisely, images of the piece goods are created at these points. This makes it possible to determine how the handling device 1 handles the piece goods 2. In other words, the piece goods information is created at these points.

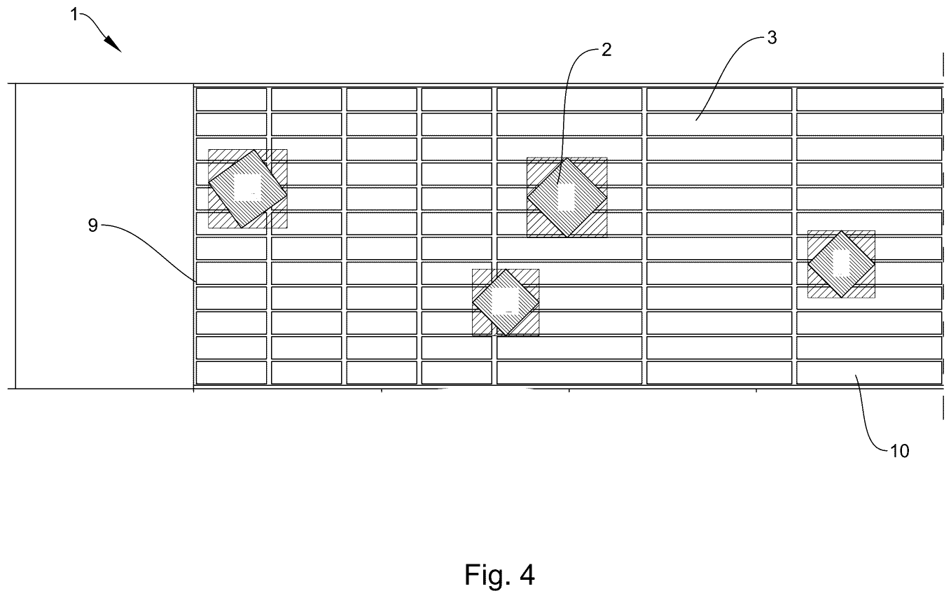

FIG. 4 is a schematic view of a handling system 1 according to an embodiment of the present disclosure. More precisely, FIG. 4 represents a view as taken by the control device 5 of the handling device 1 from the detection device 4. Here, the piece goods are simplified by a polygonal representation. Only the corners of the piece goods are detected by the detection device 4 and a polygon representation is created based on this. This can speed up the detection process and accelerate the subsequent handling of the piece goods information.

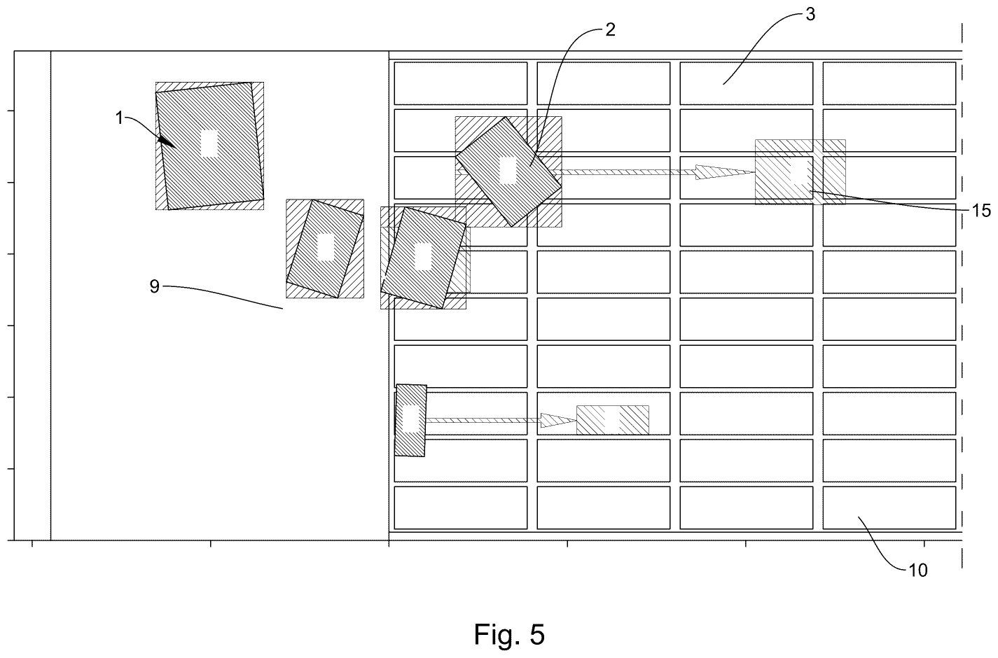

FIG. 5 is a schematic view of a handling device according to an embodiment of the present disclosure. In FIG. 5, similar to FIG. 4, it is shown how the control device 5 of the present disclosure recognizes the piece goods 2 when they are handled on the handling device 1. In addition, FIG. 5 shows a target position or a target position of the piece goods after a handling process by the handling device 1. Reference sign 15 indicates how the position of a piece good should be realized after handling by the handling device 1. In other words, the piece good should be rotated. Such a desired position can also be indicated by the key performance indicator. In other words, the key performance indicator can indicate how many piece goods should reach the desired position at the end of the handling device.

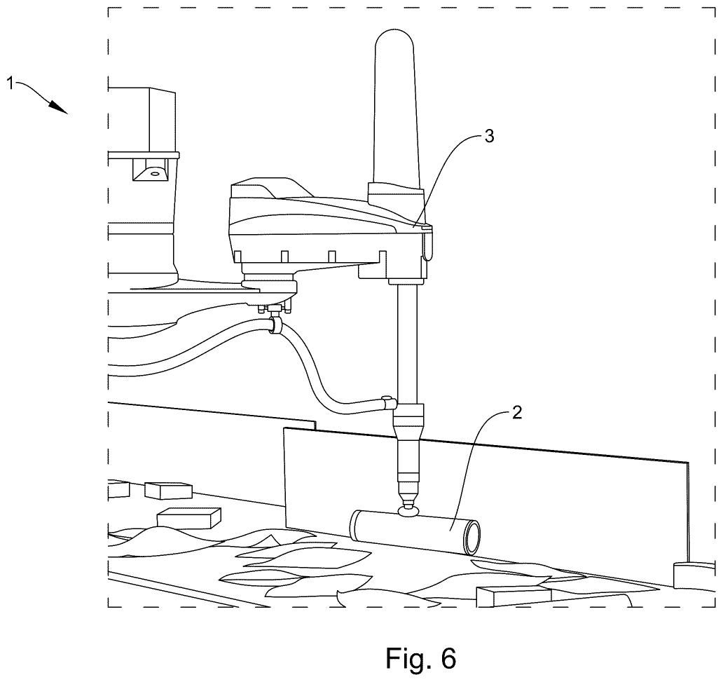

FIG. 6 is a schematic and perspective view of a handling device 1 according to a further embodiment of the present disclosure. In the present embodiment, the handling device 1 is a suction gripping device. Furthermore, in the present embodiment, similar to the embodiment described above, a detection unit 4 (not shown in the figure) is provided in order to obtain the unit load information. The other functions correspond to the function of the embodiment shown in FIG. 2.

### Reference Sign List

1 Handling device
2 Piece good
3 Controllable element
4 Capture device
5 Control device
6 Sending device
7 Data center
8 Receiving device
9 Upstream end
10 Downstream end
11 First acquisition line
12 Second recording line
13 Third acquisition line
14 Fifth acquisition line
15 Target location

The invention claimed is:

1. A computer-implemented method for determining a control strategy for controlling a handling process of at least one handling device for handling piece goods, comprising:
detecting or obtaining at least one piece good information of at least one piece good which has been handled by the handling device;
transmitting the at least one piece good information to a data center;
determining at least one key performance indicator of the handling process of the handling device based on the at least one piece good information; and
determining a control strategy for the at least one handling device based on the at least one key performance indicator.

2. The method according to claim 1, wherein the piece good information comprises a position and location information of the piece good in the handling device, a time stamp, a weight of the piece good, a nature of the piece good, a packaging information, an address information, a sender information, and/or an information about a center of gravity of the piece good.

3. The method according to claim 2, wherein the at least one key performance indicator is indicative of a gap between two piece goods, an efficiency of piece goods per unit time, a position of a piece good at the exit of the handling device, and/or an error rate of the handling of the piece good.

4. The method according to claim 3, wherein the determination of a control strategy is carried out via a digital twin of the handling device.

5. The method according to claim 4, wherein a new control strategy is tested by using the digital twin.

6. The method according to claim 5, further comprising:
comparing the control strategy of the handling device with the new control strategy of the digital twin; and
creating an evaluation of the control strategies based on the comparison.

7. The method according to claim 6, wherein the handling process of the handling device comprises the application of an algorithm, wherein the algorithm is configured based on the control strategy to output control instructions as output data based on piece goods information as input data.

8. The method according to claim 7, wherein unit load information from a plurality of handling devices is recorded in the data center.

9. The method according to claim 1, wherein the at least one key performance indicator is indicative of a gap between two piece goods, an efficiency of piece goods per unit time, a position of a piece good at the exit of the handling device, and/or an error rate of the handling of the piece good.

10. The method according to claim 1, wherein the determination of a control strategy is carried out via a digital twin of the handling device.

11. The method according to claim 10, wherein a new control strategy is tested by using the digital twin.

12. The method according to claim 10, further comprising:
comparing the control strategy of the handling device with the new control strategy of the digital twin; and
creating an evaluation of the control strategies based on the comparison.

13. The method according to claim 1, wherein the handling process of the handling device comprises the application of an algorithm, wherein the algorithm is configured based on the control strategy to output control instructions as output data based on piece goods information as input data.

14. The method according to claim 1, wherein unit load information from a plurality of handling devices is recorded in the data center.

15. A computer program comprising instructions which, when the program is executed by a computing unit, cause the computing unit to execute the method according to claim 1.

16. A handling device for handling piece goods in a handling process, comprising:
at least one controllable element for the physical handling of piece goods;
a detection device for detecting at least one piece good information of at least one piece good handled during the handling process;
a control device for controlling the at least one controllable element according to a control strategy based on the at least one piece of information;
a transmission device configured to transmit the piece goods information to a data center;
a receiving device configured to receive a new control strategy from the data center; and
wherein the control device configured to adapt the control strategy according to the new control strategy.
